(19) United States
(12) Patent Application Publication
(10) Pub. No.: US 2024/0412607 A1
(43) Pub. Date: Dec. 12, 2024

(54) COMPUTERIZED SYSTEMS AND METHODS FOR SAFETY SENSOR ACTIVATION WITHIN A LOCATION

(71) Applicant: Ademco Inc., Golden Valley, MN (US)

(72) Inventors: Sheetal R. Kadam, Karnataka (IN); Sachin Joy, Karnataka (IN); Sachin Maganti Prakash, Karnataka (IN)

(73) Assignee: Ademco Inc., Golden Valley, MN (US)

(21) Appl. No.: 18/738,552

(22) Filed: Jun. 10, 2024

Related U.S. Application Data
(60) Provisional application No. 63/507,505, filed on Jun. 12, 2023.

(51) Int. Cl. G08B 7/06; G08B 17/10; G08B 27/00

(52) U.S. Cl. CPC G08B 7/066; G08B 7/062; G08B 17/10; G08B 27/001

(57) ABSTRACT

Disclosed are systems and methods of a novel framework for automatically and dynamically recommending exit routes within/from a location during an emergency. In some embodiments, the framework can additionally, or in the alternative, provide first responders audible and/or visible indicators as to the current location and/or direction of individuals within a location. The disclosed framework, therefore, can analyze collected sensor information from a location, inclusive of smoke detector triggers and current positioning of people/pets within a location, and compile a dynamically updateable set of instructions for which such sensors can audibly and/or visibly output instructions for such people to escape to safety.

### RELATED APPLICATION(S)

This application claims priority to and the benefit of U.S. Provisional Patent Application No. 63/507,505, filed Jun. 12, 2023, the entire contents of which is incorporated herein by reference.

### FIELD OF THE DISCLOSURE

The present disclosure is generally related to location-based safety measures, and more particularly, to a decision intelligence (DI)-based computerized framework that automatically and dynamically recommends exit routes within/from a location during an emergency.

### BACKGROUND

Conventional smoke detectors are devices within a location that sense smoke, typically as an indicator of fire. Smoke detectors, also known as smoke alarms, generally issue an audible or visual alarm.

### SUMMARY OF THE DISCLOSURE

However such smoke detectors are focused on alerting individuals within a location as to an occurrence of fire. That is, conventional smoke detectors simply alert people within a location that the detector itself has detected a fire.

To that end, as discussed herein, disclosed are computerized systems and methods that provide a novel framework for automatically and dynamically recommending exit routes within/from a location during an emergency. As discussed herein, a location can be any type of building, structure or definable physical, geographic location, such as, but not limited to, a home, office, patio, garage, and the like.

According to some embodiments, the disclosed framework can detect that a fire is at location, and based on advanced computational analysis of the information related to the fire, the location, living things (e.g., people/pets) within/around the location, among other variables (e.g., which can include, but are not limited to, thermal conditions at the location, sprinkler system capabilities at the location, air quality, types of gasses, concentration of smoke, materials of ceilings, floors and walls at the location, and the like) can determine a real-time exit route for the living things within the location.

In some embodiments, information related to the exit route can be output by at least one smoke detector, which can involve a visible display, audible output, and/or haptic effect, among other types of outputs. In some embodiments, an output of the exit route can involve additional systems and/or components of a system to be triggered so as to enable a more efficient and/or safe exit (e.g., turn on the sprinklers at a greater rate for the exit route during the exit of the people so as to enable their route to be cleared from persistent dangers, for example; activate air vents along the route to re-route smoke, in another example).

Accordingly, the disclosed framework can effectuate an accurate and up-to-date reflection of the safety conditions at a location so as to enable the most safe and quickest exit from an emergency. The disclosed framework, therefore, can analyze collected sensor information from a location, inclusive of smoke detector triggers and current positioning of people/pets within a location, and compile a dynamically updateable set of instructions for which such sensors can audibly and/or visibly output instructions for such people to escape to safety.

It should be understood that while the discussion herein focuses on smoke detectors and detection of smoke and/or fire related hazards, it should be construed as limiting, as other types of hazardous conditions and/or emergency event within/around a location can be the basis of the disclosed framework's operation without departing from the scope of the instant disclosure (e.g., carbon monoxide detection, intruder detection, and the like).

According to some embodiments, a method is disclosed automatically and dynamically recommending exit routes within/from a location during an emergency. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method that automatically and dynamically recommends exit routes within/from a location during an emergency.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 illustrates an exemplary workflow according to some embodiments of the present disclosure;

FIG. 5 depicts an exemplary implementation of an architecture according to some embodiments of the present disclosure;

FIG. 6 depicts an exemplary implementation of an architecture according to some embodiments of the present disclosure; and

FIG. 7 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

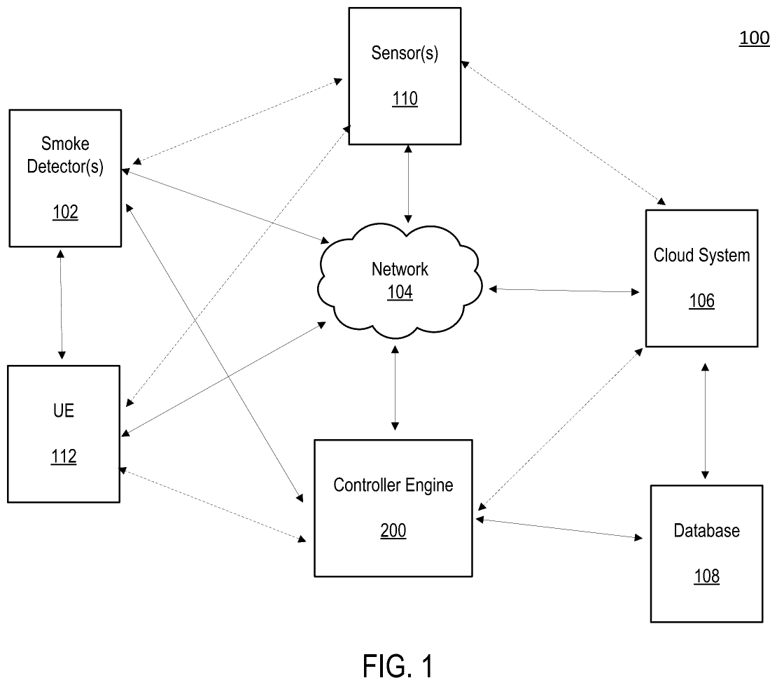

Certain embodiments and principles will be discussed in more detail with reference to the figures. With reference to FIG. 1, a system is depicted for a location 100 which includes smoke detector(s) 102, user equipment (UE) 112 (e.g., a client device, as mentioned above and discussed below in relation to FIG. 10), sensors 110, network 104, cloud system 106, database 108 and controller engine 200. It should be understood that while system 100 is depicted as including such components, it should not be construed as limiting, as one of ordinary skill in the art would readily understand that varying numbers of smoke detectors, UEs, sensors, cloud systems, databases and networks can be utilized; however, for purposes of explanation, system 100 is discussed in relation to the example depiction in FIG. 1.

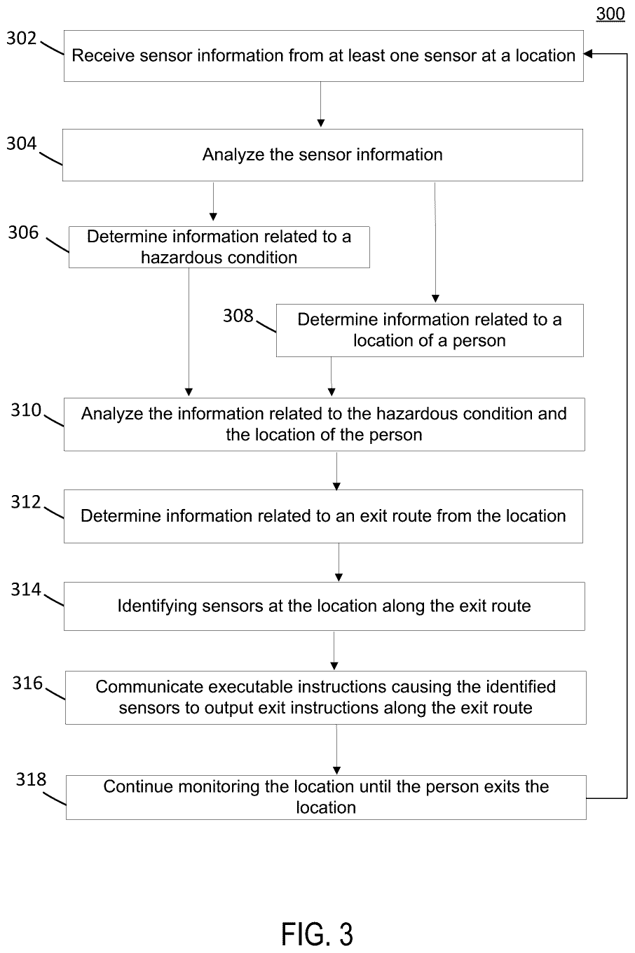

According to some embodiments, smoke detector 102 can be configured to provide audible, visible and haptic output, or some combination thereof, regarding an exit direction for a person fleeing a location. In some embodiments, the smoke detector 102 can be specifically configured with audio, visual and/or haptic components that enable the recommendations of the exit direction, as discussed below at least in relation to FIG. 3. For example, in some embodiments, the smoke detector 102 can be configured with an array of lights or light emitting diodes (LEDs), which can be configured in any shape and/or size. The configuration of the lights/LEDs enables illumination of at least a portion of the lights so as to enable an arrow or directional indication to be provided on the smoke detector 102. In some embodiments, all of the lights/LEDs of the smoke detector 102 may be illuminated, but the lights/LEDs associated with the directional output may be illuminated at a higher brightness (e.g., higher watts to such bulbs, for example).

In some embodiments, the smoke detector 102 can also be configured with at least one siren or speaker that can enable audible instructions to be output along the exit route. For example, a siren noise, and/or directional instruction can be provided (e.g., “walk forward until the staircase, and walk 2 flights down the stairs”, “be careful of fallen debris”, “crawl through this area due to smoke”, and the like). Accordingly, the audio can account for the real-time conditions in the location, for which instructions can be dynamically based. Indeed, the visible output of the lights/LEDs can be specifically configured to adapt to the real-time conditions, where the illuminated lights/LEDs can provide indications (e.g., a crawling image, a stair case, a smoke image, and the like) of the current conditions/surroundings/dangers, as discussed below.

In a similar manner to the audio and visible output, haptic effects can be provided, which may enable visibly and/or audibly impaired individuals within the location.

In some embodiments, the smoke detector 102 can also provide instructions not only to the people fleeing the location, but also to first responders (e.g., Fire Department personnel, for example). For example, the lights/LEDs and/or audio output can provide instructions to the current location and/or directional movement of the people in the building.

In some embodiments, the smoke detector 102 can provide exit instructions and person-finding instructions on a partitioned or modified display, so as to enable people to exit while aiding first responders to find such people. For example, 12 of the display can provide instructions for the people exiting, while the other 12 provides first responders information. In some embodiments, different colors, different sounds, alternating instructions (e.g., displays and/or instructions), and the like, can be utilized so as to enable instructions for all parties within a location during an emergency.

Accordingly, while the discussion herein uses a smoke detector as an example of the audio, visible and/or haptic output, it should not be construed as limiting, as any of the UE 112 and/or sensors 110 discussed herein can be specifically configured in a similar manner without departing from the scope of the instant disclosure.

According to some embodiments, UE 112 can be any type of device, such as, but not limited to, a mobile phone, tablet, laptop, sensor, Internet of Things (IoT) device, autonomous machine, and any other device equipped with a cellular or wireless or wired transceiver. In some embodiments, UE 112 can be a device associated with an individual (or set of individuals) for which security and/or climate control services are being provided. In some embodiments, UE 112 may correspond to a device of a security and/or climate service provider entity (e.g., a thermostat, whereby the device can be and/or can have corresponding sensors 110, as discussed herein).

In some embodiments, a peripheral device (not shown) can be connected to UE 112, and can be any type of peripheral device, such as, but not limited to, a wearable device (e.g., smart watch), printer, speaker, sensor, and the like. In some embodiments, a peripheral device can be any type of device that is connectable to UE 112 (and/or sensor 110 and/or smoke detector 102) via any type of known or to be known pairing mechanism, including, but not limited to, Wi-Fi, Bluetooth™, Bluetooth Low Energy (BLE), NFC, and the like.

According to some embodiments, sensors 110 can correspond to sensors associated with a location of system 100. In some embodiments, the sensors 110 can be, but are not limited to, temperature sensors (e.g., thermocouples, resistance temperature detectors (RTDs), thermistors, semiconductor based integrated circuits (IC), thermometers, and the like, for example) cameras, glass break detectors, motion detectors, door and window contacts, heat and smoke detectors, carbon monoxide (CO) and/or carbon dioxide (CO₂) detectors, passive infrared (PIR) sensors, time-of-flight (ToF) sensors, and the like. For example, sensor 110 can be a smoke detector similar to smoke detector 102.

In some embodiments, the sensors 110 can involve an IoT environment and/or be associated with devices associated with the location of system 100, such as, for example, lights, smart locks, garage doors, smart appliances (e.g., thermostat, refrigerator, television, personal assistants (e.g., Alexa®, Nest®, for example)), smart phones, smart watches or other wearables, tablets, personal computers, and the like, and some combination thereof. For example, the sensors 110 can include the sensors on UE 112 (e.g., smart phone) and/or peripheral device (e.g., a paired smart watch).

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a security and/or climate-control system provider, which has associated network resources hosted on the internet or private network (e.g., network 104), which enables (via engine 200) the security management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of UE 112/detector 102 and the UE 112/detector 102, sensors 110, and the services and applications provided by cloud system 106 and/or controller engine 200.

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

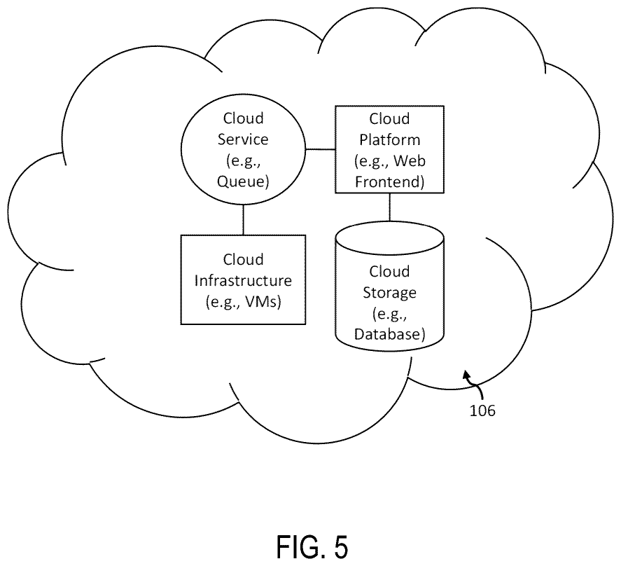

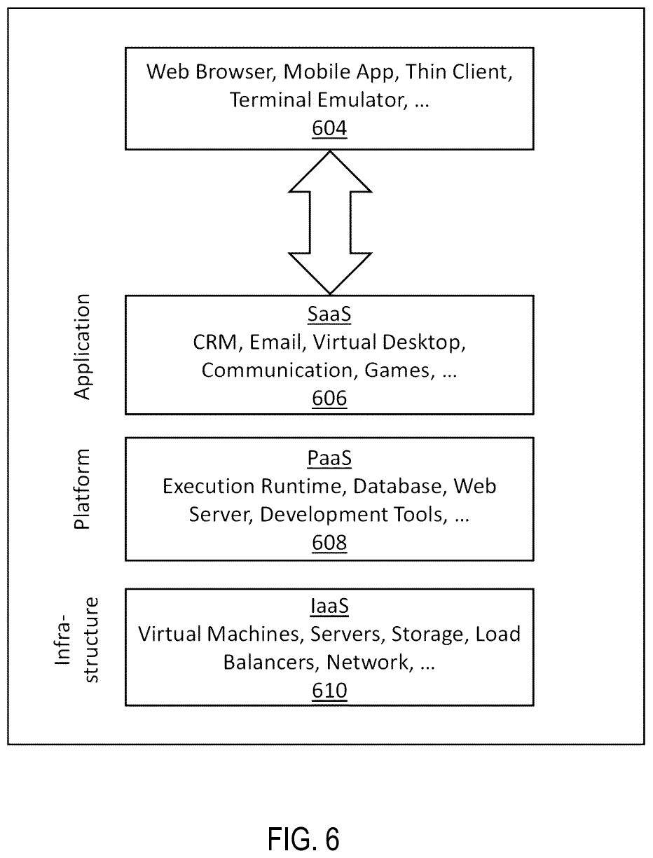

Turning to FIG. 5 and FIG. 6, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure a service (IaaS) 610, platform as a service (PaaS) 608, and/or software as a service (SaaS) 606 using a web browser, mobile app, thin client, terminal emulator or other endpoint 604. FIG. 5 and FIG. 6 illustrate schematics of non-limiting implementations of the cloud computing/architecture(s) in which the exemplary computer-based systems for administrative customizations and control of network-hosted APIs of the present disclosure may be specifically configured to operate.

Turning back to FIG. 1, according to some embodiments, database 108 may correspond to a data storage for a platform (e.g., a network hosted platform, such as cloud system 106, as discussed supra), a plurality of platforms, and/or UE 112 and/or sensors 110. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Controller engine 200, as discussed above and further below in more detail, can include components for the disclosed functionality. According to some embodiments, controller engine 200 may be a special purpose machine or processor, and can be hosted by a device on network 104, within cloud system 106, on UE 112, and/or detector 102 (and/or on sensors 110). In some embodiments, engine 200 may be hosted by a server and/or set of servers associated with cloud system 106.

According to some embodiments, as discussed in more detail below, controller engine 200 may be configured to implement and/or control a plurality of services and/or microservices, where each of the plurality of services/microservices are configured to execute a plurality of workflows associated with performing the disclosed security management. Non-limiting embodiments of such workflows are provided below.

According to some embodiments, as discussed above, controller engine 200 may function as an application provided by cloud system 106. In some embodiments, engine 200 may function as an application installed on a server(s), network location and/or other type of network resource associated with system 106. In some embodiments, engine 200 may function as an application installed and/or executing on UE 112 and/or detector 102. In some embodiments, such application may be a web-based application accessed by UE 112, smoke detector 102 and/or devices associated with sensors 110 over network 104 from cloud system 106. In some embodiments, engine 200 may be configured and/or installed as an augmenting script, program or application (e.g., a plug-in or extension) to another application or program provided by cloud system 106 and/or executing on UE 112, sensors 110 and/or smoke detector 102.

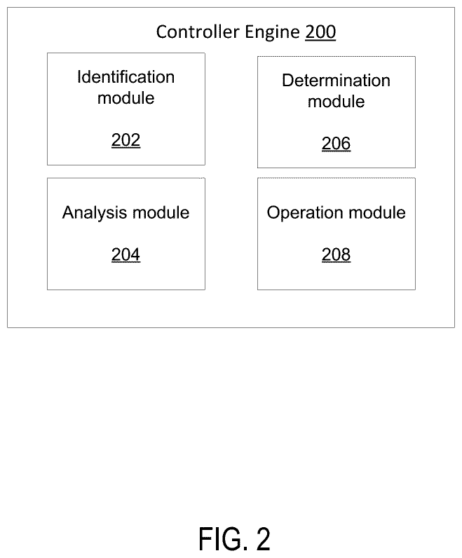

As illustrated in FIG. 2, according to some embodiments, controller engine 200 includes identification module 202, analysis module 204, determination module 206 and operation module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

Turning to FIG. 3, Process 300 provides non-limiting example embodiments of the disclosed framework for real-time indication of exit routes from a location during an emergency. As discussed in more detail below, the disclosed framework provides novel functionality for a location, and the sensors and smoke detectors operating therein, to output (e.g., display an arrow, for example) an exit direction for a person to exit the location during an emergency (e.g., fire), which can be based on and/or provide additional information related to, but not limited to, the climate at the location (e.g., air quality, types of gasses, concentration and smoke detection levels, as well as direction of the fire's movement, and the like), direction of the user's movement, and the like. Thus, the disclosed framework, via execution of the steps of Process 300, can provide functionality for a robust evacuation system that can enable not only the safest route, but the most efficient route.

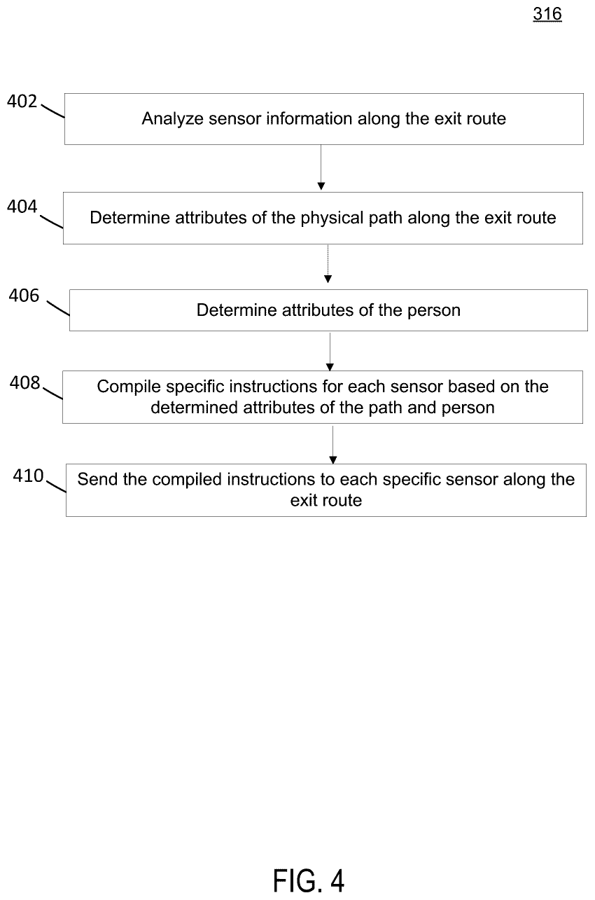

According to some embodiments, Steps 302 and 314 can be performed by identification module 202 of controller engine 200; Steps 304 and 310 can be performed by analysis module 204; Steps 306-308 and 312 can be performed by determination module 206; and Step 316 (and sub-steps 402-410 of FIG. 4, discussed infra) and Step 318 can be performed by operation module 208.

According to some embodiments, Process 300 begins with Step 302 where engine 200 can receive sensor information from at least one sensor at the location. For example, as discussed above at least in relation to FIG. 1, a smoke detector 102 can detect smoke within a room at a home.

In some embodiments, the sensor information received in Step 302 can be collected according to a criteria, which can be in accordance with, but not limited to, a time period, a time interval, a detected event, continuously, a user request, and the like, or some combination thereof.

In Step 304, engine 200 can analyze the collected sensor information. In some embodiments, the sensor information can be parsed, whereby data and/or metadata related to a detected event can be identified and/or extracted from the data. For example, fire event information can be identified, which can be related to, but not limited to, position within the location (e.g., which room, which floor, and the like), spread of fire, thermal conditions, number of people in the location, types or identities of people, current movement direction of each person, number and types of pets (and/or plants), location and quantity of flammable materials, air quality, fire intensity, other detect gas measurements, and the like, or some combination thereof.

Thus, in Step 306, engine 200 can determine information related to the hazardous condition (e.g., where the fire is located, its heat intensity, amount of smoke, and the like); and in Step 308, engine 200 can determine where the people (and pets) in the location are located, how many there are, and their types (e.g., height, weight, ages, for example).

In some embodiments, engine 200 can implement any type of known or to be known computational analysis technique, algorithm, mechanism or technology to perform the analysis and determination in Steps 304-308.

In some embodiments, engine 200 may include a specific trained artificial intelligence/machine learning model (AI/ML), a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like. By way of a non-limiting example, engine 200 can implement an XGBoost algorithm for regression and/or classification to analyze the sensor data, as discussed herein.

According to some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

In some embodiments, the determined information from Step 306 and Step 308 can be stored in database 108, as discussed above.

In Step 310, engine 200 can analyze the determined information from Step 306 and Step 308, which can be effectuated via any of the known or to be known AI/ML model techniques discussed above. And, in Step 312, based on a computational and comparative analysis of the hazardous condition and person information from Step 310, engine 200 can determine an exit route from the location for each person.

For example, if the fire is located at a door way to a stairwell on the north side of the building on the second floor, and a person is near that location, an exit route from the person's current location to the stairwell on the south side can be compiled and generated via the determination in Step 312.

According to some embodiments, the exit route can include specific steps, information and/or movements, which can correspond to specific portions of the location and/or be associated with specific sensors. For example, engine 200 can leverage the AI/ML models (e.g., computer vision technology from camera sensors) to perform segmentation of smoke from fire related hazards (e.g., a user can walk/run through smoke, but not fire, per se). In another non-limiting example, engine 200 can leverage thermal information from particular sensors (e.g., provide information to avoid areas where heat temperatures are beyond a threshold—for example—while no fire or smoke in an area of a location, the path may be on a floor above the fire, thereby causing a dangerous path that may be subject to cave ins). In another non-limiting example, engine 200 can leverage the detection of flammable materials to compile the exit route (e.g., avoid areas of such materials at all cost—for example, avoid an exit from the garage where gas and other combustible materials may be located. And, in yet another non-limiting example, engine 200 differentiate a type of user (e.g., child vs. adult vs. elderly), and optimize their path based on their abilities (and/or their positional relationship to other users (e.g., if a child is near an adult, the child's path can assimilate to the adults (as the adult may be able to pick them up, for example)).

In Step 314, engine 200 can locate and/or identify the sensors along the determined exit route. In some embodiments, each smoke detector 102 located along the route determined in Step 312 can be identified. In some embodiments, such identification can involve pinging each sensor so they are primed for reception of additional instructions.

In Step 316, engine 200 can compile and communicate executable instructions causing each identified sensor along the exit route to output exit instructions. For example, each sensor can be provided specific instructions that are particular to their position in the location and along the exit route so as to display contextually relevant content related to the person's movement along the exit route in relation to the person's currently tracked position and the position of the exit. For example, a sensor can display an arrow pointing the person to the direction of the next sensor (and arrow) and/or the exit from the location.

Turning to FIG. 4, provided are sub-steps of Step 316, which include Steps 402-410. As discussed herein, FIG. 4 provides non-limiting embodiments for determining and/or identifying conditions along the exit route for which the exit route is based and/or can be modified.

In sub-Step 402, engine 200 can collect and analyze the sensor information along the exit route. Such collection and analysis can be performed in a similar manner as discussed above at least in relation to Steps 302-304, supra.

In sub-Step 404, engine 200 can determine attributes of the physical path along the exit route. Such determination can be performed in a similar manner as discussed above at least in relation to Step 306, supra.

In sub-Step 406, attributes of the person (or people) at the location can be determined. Such attributes can correspond to, but are not limited to, the type of person, movements of the person (e.g., direction, speed, and the like), position within the location (e.g., current and/or starting point), and the like. In some embodiments, such determination can be performed in a similar manner as discussed above at least in relation to Step 308, supra.

In Step sub-408, engine 20 can compile instructions for each sensor based on the determined attributes of the exit path and person. Such compilation can be performed via any the AI/ML models, as discussed above (e.g., in a similar manner as to the performance of Steps 312-314, supra). And, in sub-Step 410, engine 200 can send each set of specifically compiled instructions to a respective sensor so as to enable that specific sensor to output specifically configured instructions.

For example, along an exit path are sensors 1, 2 and 3. Sensor 1 can display an arrow via the LEDs on the sensor, sensor 2 can display an arrow and audible output instructions to continue “for 20 more feet in the same direction” (for example), and sensor 3 can output blinking lights and audible state to “crawl for 10 feet” due to intensity of smoke conditions in that area of the location.

In some embodiments, the sensors can be associated with additional emergency components, as discussed above, which can be triggered. For example, continuing with the above example, sensor 4 can be positioned with a door lock on an exit door to a stairwell that can be triggered based on the position of the fire. For example, if the fire is within that stairwell, the door lock sensor may be engaged, thereby preventing access to that stairwell. In another example, sensor 4 may be associated with a sprinkler along the exit route; therefore, as the user approaches the area around sensor 4, the water flow for that associated sensor may be increased, which can provide extra safeguards that flames or embers in that area do not cause an uptick in flames as the user traverses that respective area.

Turning back to Process 300, upon communication of the information to each sensor along the exit route, engine 200 can monitor (e.g., continuously, according to a time period and/or detected event) the location until it is determined that the person has exited the location safely. Accordingly, in Step 318, the monitoring can trigger the collection of additional sensor information via Step 302 so that Process 300 recursively operates until the person is deemed safe. In some embodiments, such recursive operation can enable real-time tracking of the person to ensure they stay on the path, and if they stray, then other sensors can be triggered to either update their route and/or redirect them back to the path. In some embodiments, such sensor updates can also provide updates to the fire, which can cause dynamic updates to the path, which can be effectively relayed via the operations of the steps of Process 300, discussed above.

Accordingly, in some embodiments, Process 300 can additionally be utilized to enable first responders to locate individuals within the location, as discussed above. Thus, rather than providing an exit route, the route/path for the first responders can be respective to the tracked location of the individuals trapped within the location, which can be performed in a similar manner as discussed above.

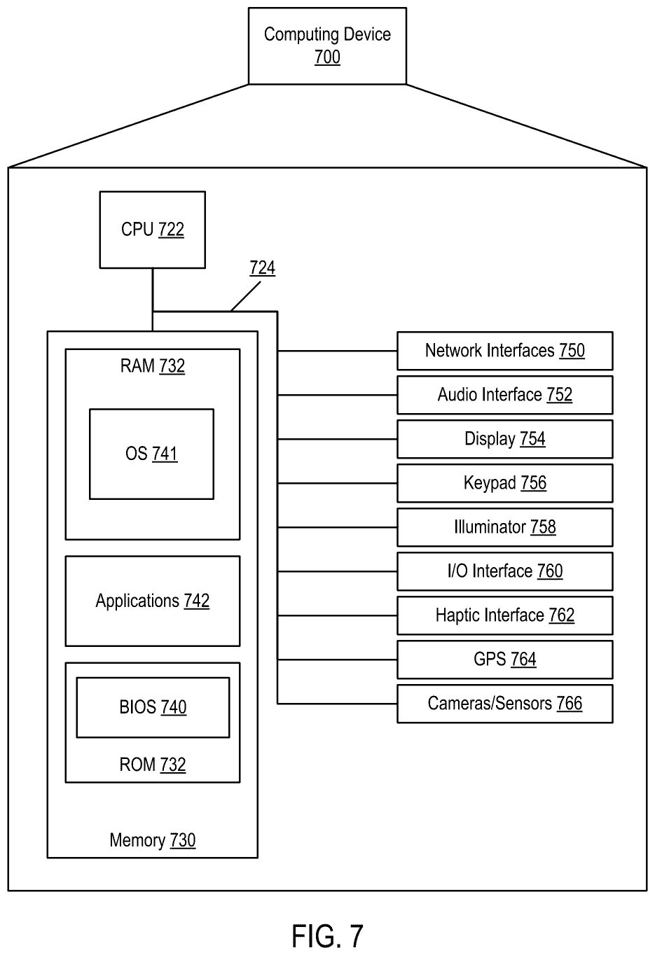

FIG. 7 is a schematic diagram illustrating a client device showing an example embodiment of a client device that may be used within the present disclosure. Client device 700 may include many more or less components than those shown in FIG. 7. However, the components shown are sufficient to disclose an illustrative embodiment for implementing the present disclosure. Client device 700 may represent, for example, UE 112 discussed above at least in relation to FIG. 1.

As shown in the figure, in some embodiments, Client device 700 includes a processing unit (CPU) 722 in communication with a mass memory 730 via a bus 724. Client device 700 also includes a power supply 726, one or more network interfaces 750, an audio interface 752, a display 754, a keypad 756, an illuminator 758, an input/output interface 760, a haptic interface 762, an optional global positioning systems (GPS) receiver 764 and a camera(s) or other optical, thermal or electromagnetic sensors 766. Device 700 can include one camera/sensor 766, or a plurality of cameras/sensors 766, as understood by those of skill in the art. Power supply 726 provides power to Client device 700.

Client device 700 may optionally communicate with a base station (not shown), or directly with another computing device. In some embodiments, network interface 750 is sometimes known as a transceiver, transceiving device, or network interface card (NIC).

Audio interface 752 is arranged to produce and receive audio signals such as the sound of a human voice in some embodiments. Display 754 may be a liquid crystal display (LCD), gas plasma, light emitting diode (LED), or any other type of display used with a computing device. Display 754 may also include a touch sensitive screen arranged to receive input from an object such as a stylus or a digit from a human hand.

Keypad 756 may include any input device arranged to receive input from a user. Illuminator 758 may provide a status indication and/or provide light.

Client device 700 also includes input/output interface 760 for communicating with external. Input/output interface 760 can utilize one or more communication technologies, such as USB, infrared, Bluetooth™, or the like in some embodiments. Haptic interface 762 is arranged to provide tactile feedback to a user of the client device.

Optional GPS transceiver 764 can determine the physical coordinates of Client device 700 on the surface of the Earth, which typically outputs a location as latitude and longitude values. GPS transceiver 764 can also employ other geo-positioning mechanisms, including, but not limited to, triangulation, assisted GPS (AGPS), E-OTD, CI, SAI, ETA, BSS or the like, to further determine the physical location of client device 700 on the surface of the Earth. In one embodiment, however, Client device may through other components, provide other information that may be employed to determine a physical location of the device, including for example, a MAC address, Internet Protocol (IP) address, or the like.

Mass memory 730 includes a RAM 732, a ROM 734, and other storage means. Mass memory 730 illustrates another example of computer storage media for storage of information such as computer readable instructions, data structures, program modules or other data. Mass memory 730 stores a basic input/output system (“BIOS”) 740 for controlling low-level operation of Client device 700. The mass memory also stores an operating system 741 for controlling the operation of Client device 700.

Memory 730 further includes one or more data stores, which can be utilized by Client device 700 to store, among other things, applications 742 and/or other information or data. For example, data stores may be employed to store information that describes various capabilities of Client device 700. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 700.

Applications 742 may include computer executable instructions which, when executed by Client device 700, transmit, receive, and/or otherwise process audio, video, images, and enable telecommunication with a server and/or another user of another client device. Applications 742 may further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving, by a device at a location, from a sensor at the location, information indicating a hazardous condition is currently occurring at the location;
determining, by the device, a position within the location related to the hazardous condition, the determination further comprising identifying a current position of a person at the location;
identifying, by the device, an exit direction for the person, the exit direction corresponding to an exit from the location, the exit direction being based on the position of the hazardous condition and the current position of the person; and
communicating, by the device, to the sensor, instructions related to the exit direction, the instructions causing the sensor to output an indication of a route for the person to travel within the location to the exit.

2. The method of claim 1, wherein the output comprises at least one of an audible sound and visible display.

3. The method of claim 1, further comprising:
receiving, from the sensor, updated sensor information related to a development of the hazardous condition;
updating the exit direction based on the updated sensor information; and
communicating updated instructions to the sensor corresponding to the updated exit direction.

4. The method of claim 1, further comprising:
receiving information related to the exit direction; and
programming the sensor based on the received information.

5. The method of claim 4, wherein the received information comprises data related to at least one of a position of the sensor within the location, a relationship of the sensor to other sensors at the location and a position of the sensor to the exit.

6. The method of claim 1, wherein the location comprises a plurality of sensors, each of the plurality of sensors being programmed with instructions related to a respective exit direction.

7. The method of claim 1, wherein the location comprises a plurality of exits, wherein the sensor comprises functionality for displaying exit directions for each of the plurality of exits.

8. The method of claim 1, wherein the hazardous condition comprises a fire.

9. The method of claim 1, further comprising:
communicating instructions to the sensor related to the current position of the person, wherein the instructions cause a directional output to be displayed providing guidance to a first responder as to a location of the person.

10. The method of claim 1, wherein the location comprises a definable physical area for which the smoke detector is positioned.

11. A device comprising:
a processor configured to:
receive, from a sensor at a location, information indicating a hazardous condition is currently occurring at the location;
determine a position within the location related to the hazardous condition, the determination further comprising identifying a current position of a person at the location;
identify an exit direction for the person, the exit direction corresponding to an exit from the location, the exit direction being based on the position of the hazardous condition and the current position of the person; and
communicate to the sensor instructions related to the exit direction, the instructions causing the sensor to output an indication of a route for the person to travel within the location to the exit.

12. The device of claim 11, wherein the output comprises at least one of an audible sound and visible display.

13. The device of claim 11, wherein the processor is further configured to:
receive, from the sensor, updated sensor information related to a development of the hazardous condition;
update the exit direction based on the updated sensor information; and
communicate updated instructions to the sensor corresponding to the updated exit direction.

14. The device of claim 11, wherein the processor is further configured to:
receive information related to the exit direction, wherein the received information comprises data related to at least one of a position of the sensor within the location, a relationship of the sensor to other sensors at the location and a position of the sensor to the exit; and
program the sensor based on the received information.

15. The device of claim 11, wherein the processor is further configured to:
communicate instructions to the sensor related to the current position of the person, wherein the instructions cause a directional output to be displayed providing guidance to a first responder as to a location of the person.

16. A non-transitory computer-readable storage medium tangibly encoded with computer-executable instructions that when executed by a device, perform a method comprising:
receiving, by the device at a location, from a sensor at the location, information indicating a hazardous condition is currently occurring at the location;
determining, by the device, a position within the location related to the hazardous condition, the determination further comprising identifying a current position of a person at the location;
identifying, by the device, an exit direction for the person, the exit direction corresponding to an exit from the location, the exit direction being based on the position of the hazardous condition and the current position of the person; and
communicating, by the device, to the sensor, instructions related to the exit direction, the instructions causing the sensor to output an indication of a route for the person to travel within the location to the exit.

17. The non-transitory computer-readable storage medium of claim 16, wherein the output comprises at least one of an audible sound and visible display.

18. The non-transitory computer-readable storage medium of claim 16, further comprising:
receiving, from the sensor, updated sensor information related to a development of the hazardous condition;
updating the exit direction based on the updated sensor information; and
communicating updated instructions to the sensor corresponding to the updated exit direction.

19. The non-transitory computer-readable storage medium of claim 16, further comprising:
receiving information related to the exit direction, wherein the received information comprises data related to at least one of a position of the sensor within the location, a relationship of the sensor to other sensors at the location and a position of the sensor to the exit; and
programming the sensor based on the received information.

20. The non-transitory computer-readable storage medium of claim 16, further comprising:
communicating instructions to the sensor related to the current position of the person, wherein the instructions cause a directional output to be displayed providing guidance to a first responder as to a location of the person.
